(19) United States
(12) Patent Application Publication
(10) Pub. No.: US 2007/0255432 A1
(43) Pub. Date: Nov. 1, 2007

(54) HIGH DEFINITION AUDIO ARCHITECTURE

(75) Inventors: Jau Soon CHEE, Singapore (SG); Adrian JONATAN, Singapore (SG)

Correspondence Address: CREATIVE LABS, INC.;LEGAL DEPARTMENT, 1901 MCCARTHY BLVD, MILPITAS, CA, 95035, US

(73) Assignee: CREATIVE TECHNOLOGY LTD, Singapore (SG)

(21) Appl. No.: 11/380,482

(22) Filed: Apr. 27, 2006

(51) Int. Cl. G06F 17/00

(52) U.S. Cl. 700/94

(57) ABSTRACT

In a preferred embodiment, there is provided apparatus locatable between a host interface on the upstream side of the apparatus and one or more non-High Definition Audio (HDA)-compatible Coder/Decoders (CODECs) on the downstream side of the apparatus. The apparatus comprises a High Definition Audio (HDA) controller connectable to the host interface on the upstream side of the apparatus, and a logic circuit on the downstream side of the HDA controller. The logic circuit is connectable to the one or more non-HDA-compatible CODECs on the downstream side of the apparatus and is compatible with the HDA controller on the upstream side of the logic circuit. The logic circuit is also arranged to be able to send responses to the HDA controller, during start up and during normal operation, which emulate the responses of HDA-compatible CODECs.

### FIELD OF THE INVENTION

The invention relates to HDA compatible apparatus for communicating between a host interface and one or more Coder/Decoders (CODECs).

### BACKGROUND OF THE INVENTION

Intel® High Definition Audio (HDA) is a specification for integrated audio that is capable of playing back more channels than conventional integrated audio specifications and at a higher quality. One of the main aims of HDA is to support high quality audio in a PC (Personal Computer) environment. The HDA specification is set out in “Intel High Definition Audio Specification Revision 1.0, Apr. 15, 2004”.

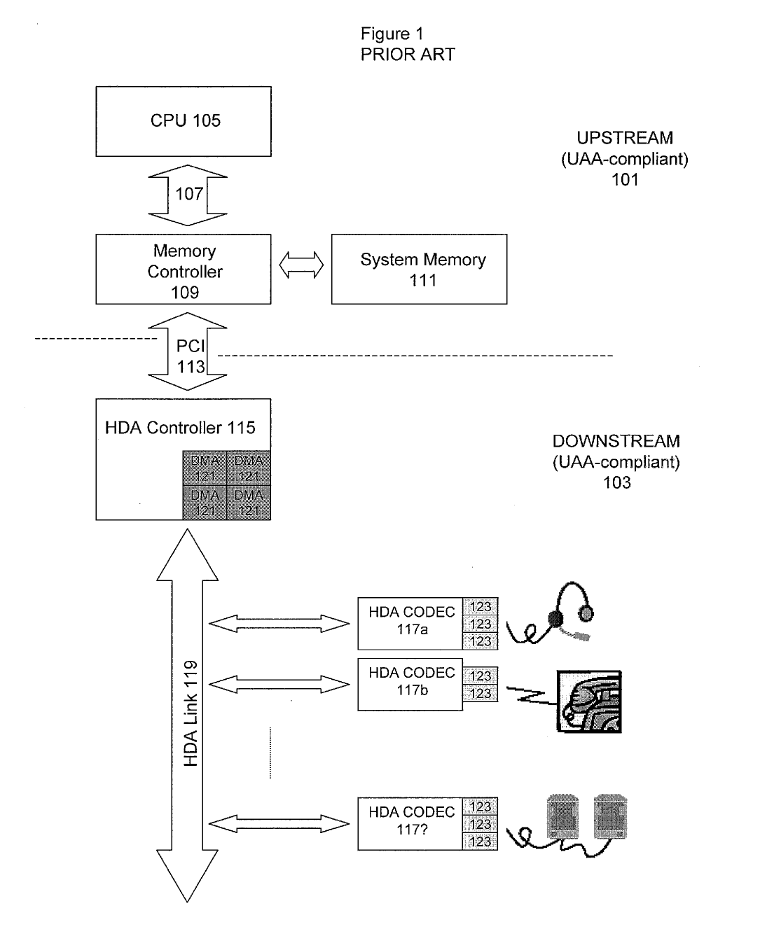

A typical hardware configuration for HDA architecture is shown in FIG. 1. The architecture is split into an upstream portion 101 and a downstream portion 103. The upstream portion 101 includes a Central Processing Unit (CPU) 105 connected via a host bus 107 to a memory controller 109. Memory controller 109 has access to system memory 111 and the memory controller 109 is connected to the downstream portion 103 via a Peripheral Component Interconnect (PCI) 113 or some other system bus. The downstream portion 103 includes an HDA controller 115 connected to a number of HDA CODECs 117a, 117b . . . via an HDA link 119. The codename for many HDA devices is “Azalia” so HDA controller 115 may alternatively be termed an Azalia controller, HDA link 119 may alternatively be termed an Azalia link (or Audio Codec link in older terminology) and the HDA CODECs 117a . . . may alternatively be termed Azalia CODECs.

The HDA controller 115 is a bus mastering I/O peripheral, which is connected to the system memory via a PCI (or some other suitable peripheral attachment host interface). The HDA controller 115 includes one or more DMA (Direct Memory Access) engines 121, each of which can be set up to transfer a single audio stream between the system memory 111 and an HDA CODEC 117a . . . .

The HDA controller 115 is physically connected to one or more of the Azalia CODECs 117a . . . via HDA link 119. The HDA link 119 conveys serialized data between the HDA controller 115 and the CODECs 117a . . . . The HDA link 119 has a fixed protocol which provides an optimum standard for transfer of data. The HDA link allows commands to be sent from the HDA Controller to the CODECs (e.g. for volume control) and allows digital data to be transmitted from the HDA Controller to the CODECs using a standard protocol. The HDA link enables a user to connect any desired HDA CODEC on the downstream side.

One or more Azalia CODECs 117a, 117b . . . are connected to the HDA link 119. A CODEC extracts one or more audio streams from the time multiplexed link protocol and converts them to an output stream through one or more converters 123. A converter 123 typically converts a digital stream to an analogue signal (or vice-versa) but may also provide additional support functions of a modem and be attached to a telephone line, and may optionally also have some other functions. Some possible downstream connections are shown as headphones, a telephone line and speakers but the outputs are not limited to these examples.

In the conventional HDA architecture like that shown in FIG. 1, all the CODECs used must be UAA (Universal Audio Architecture) compatible and the HDA controller and HDA CODECs work with the same standard protocol. This means that the user is restricted to HDA/Azalia specific CODECs only. An example of an HDA compatible CODEC is STAC9200 from SigmaTel. Other standard CODECs which are not UAA-compatible, cannot be connected on the downstream side. After power up, the host will perform enumeration to establish which I/Os (Inputs/Outputs) are connected. This is done by communication between the peripheral HDA controller 115 and the HDA CODECs 117a . . . via the HDA link 119.

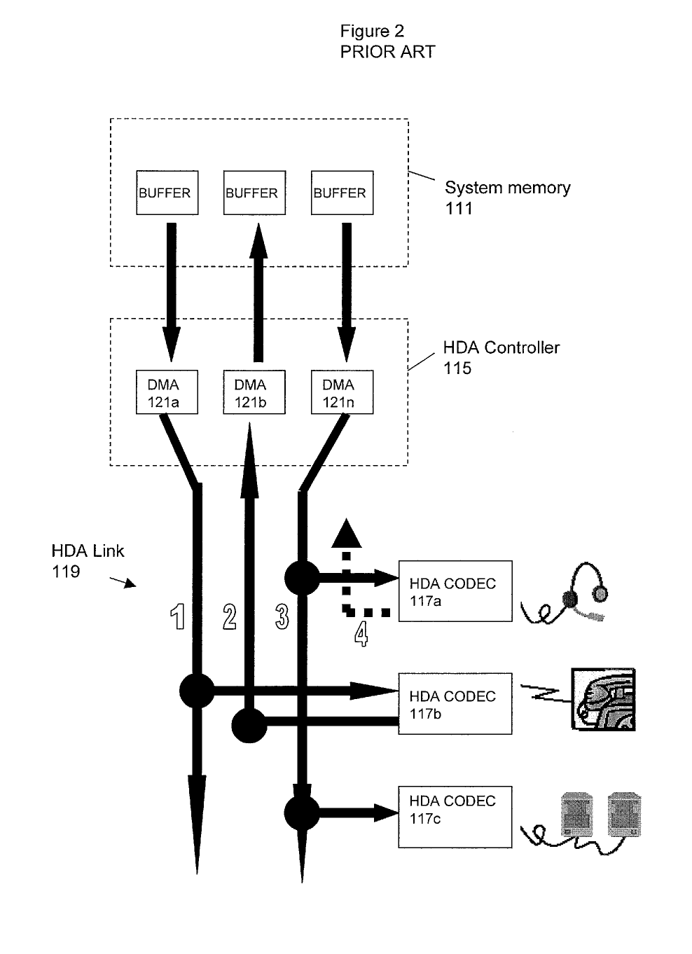

HDA architecture like that shown in FIG. 1 introduces the idea of streams and channels for organizing data to be transmitted via the HDA link. A stream is a logical or virtual connection created between a system memory buffer and a CODEC, and each stream is driven by a single DMA engine through the HDA link. A stream contains one or more channels of data, each of which is bound to a single converter in a CODEC. FIG. 2 shows streaming in conventional architecture like that shown in FIG. 1. The same reference numerals are used in FIGS. 1 and 2 to indicate the same components.

FIG. 2 is a modified version of FIG. 1 showing only those components of FIG. 1 that are necessary to illustrate the concept of streaming. System memory 111 includes buffers 201a, 201b and 201c. System memory 111 is connected to HDA Controller 115 (via memory controller 109 and PCI 113—not shown in FIG. 2) which includes DMA engines 121a, 121b, 121c. Buffer 201a is connected to DMA engine 121a, buffer 201b is connected to DMA engine 121b and buffer 201c is connected to DMA engine 121c. Streams are transmitted between the HDA Controller 115 and the CODECs 117a, 117b and 117c via the HDA link 119. In FIG. 2, four streams are shown for the purposes of illustration.

Referring to FIG. 2, output streams may be bound to more than one CODEC (e.g. stream 3 may be a two-channel stream rendered by HDA CODEC 117a on a headset and by HDA CODEC 117c on speakers) but input streams must be bound to only a single HDA CODEC (e.g. stream 2 contains only one channel—the input side of a modem). Each active stream has an allocated DMA engine 121n in the HDA Controller 115. If a DMA engine is not available, a stream must remain inactive until one becomes available (e.g. stream 4 in FIG. 2 is not connected to a DMA Engine and is therefore inactive). The HDA link operates a time-multiplexed system, which means that each CODEC is allocated a particular time slot in which to transmit/receive and, once that time slot is over, then has to wait its turn until its next time slot on the next cycle. While a given stream is being transmitted, the link between the DMA Engine 121 and the CODEC(s) 117 is fixed.

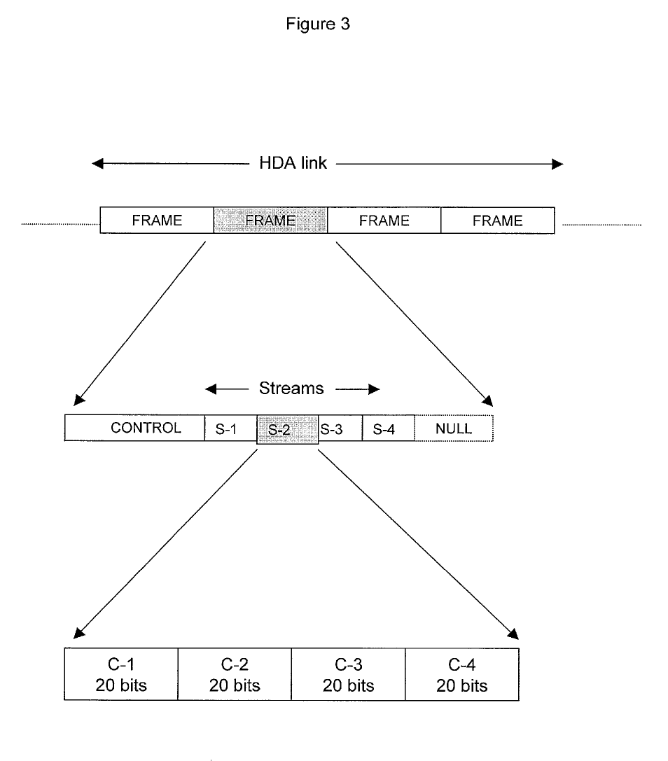

FIG. 3 shows the structure of data transferred on the HDA link 119. Each input signal in the link transmits a series of packets or frames. This is shown in the top portion of FIG. 3. In the middle portion of FIG. 3, we see that each frame contains control information (discussed below) and then as many sample blocks (S-1, S-2, S-3 . . . ) as are needed. Any unused space in the frame is filled with NULLs so that each frame takes the same amount of time to be transmitted. The lower portion of FIG. 3 shows that, in this example, the sample block S-2 has four channels C-1, C-2, C-3 and C-4 each having 20 bits. Each channel is bound for a different CODEC. The frames are transmitted at appropriate intervals along the HDA link, according to the operating sample rate e.g. at 48 kHz, a frame is transmitted every 20.83 μs. The HDA controller 115 and the HDA CODECs 117a . . . function with a single protocol so that appropriately framed data can be sent by the HDA controller and correctly received by the HDA CODECs 117a . . . and sent by the CODECs and received by the controller.

The HDA controller 115 uses a Command Outbound Ring Buffer (CORB) mechanism to pass commands to the HDA CODECs 117a . . . . The CORB is a circular buffer located in the system memory 111, that is used to pass commands from software to CODECs connected to the HDA link 119. The HDA controller 115 uses the DMA engines 121 to fetch the outbound commands from the CORB and places them in the Control bits at the start of each frame (see FIG. 3).

The responses from the CODECs 117a . . . are sent to the HDA controller 115 via a Response Inbound Ring Buffer (RIRB) mechanism. The RIRB is a circular buffer located in the system memory 111 that is used to store responses from the CODECs. Responses can either be solicited (e.g. in response to a command from the HDA controller) or unsolicited (e.g. sent by the CODEC to signal an event).

As already mentioned, the Intel® HDA Specification requires a UAA-compatible CODEC on the downstream side of the HDA Controller in order for the bus driver to be loaded correctly. In addition, non-HDA CODECs do not have the correct interface for the HDA link. Thus, CODECs used in the FIG. 1 conventional HDA architecture must be UAA-compatible. This means that the number of CODECs available to use with HDA architecture is restricted and those available do not have as good performance (e.g. Signal to Noise Ratio, SNR) as some other standard CODECs e.g. for I2S or S/PDIF. It would be advantageous to be able to connect standard non-UAA-compatible CODECs to HDA architecture in order to give the user a greater choice of CODECs and thereby allow an improvement in audio quality at the same time as being able to use the HDA architecture.

### SUMMARY OF THE INVENTION

According to a first aspect of the invention, there is provided apparatus arranged to communicate with a host interface and one or more non-High Definition Audio (HDA)-compatible Coder/Decoders (CODECs), the apparatus comprising: a logic circuit connectable to the one or more non-HDA-compatible CODECs and being compatible with a HDA controller, the logic circuit being arranged to send responses to the HDA controller, which emulate responses of HDA-compatible CODECs.

At the host interface, the host does not “see” any difference between the arrangement of the invention and conventional arrangements. However, on the downstream side of the logic circuit, the logic circuit can be connected to standard CODECs i.e. non-HDA-compatible CODECs. This means that standard CODECs can be used with HDA architecture. This allows the user a greater choice of CODECs, which means that improved sound quality can potentially be achieved.

The apparatus may form part of a sound card and thus, the apparatus may further include a HDA controller that is compatible with the logic circuit and which is connectable to the host interface. Advantageously, the apparatus is in the form of an integrated circuit (IC) i.e. the HDA controller and emulator logic circuit are formed as a single IC. This would reduce the manufacturing costs of the apparatus.

In the described embodiment, the host interface is a Peripheral Component Interface (PCI). Other possible host interfaces are USB and 1394.

At least one of the one or more CODECs may be a CODEC for Sony/Phillips Digital Interface (S/PDIF). S/PDIF is a standard audio file transfer format developed jointly by the Sony and Phillips corporations. S/PDIF allows the transfer of digital audio signals from one device to another without having to be converted first to an analogue format.

At least one of the one or more CODECs may be an Inter-IC-Sound (I2S) CODEC. I2S is an electrical bus interface standard used for connecting digital audio devices together. The I2S bus separates clock and data signals, resulting in a very low jitter connection.

Other examples of types of CODECs include CS4382 from Cirrus Logic, UDA1361TS from Phillips. These are both standard (non-HDA-compatible CODECs).

The host interface may be locatable on the upstream side of the apparatus, and the one or more non-HDA-compatible CODECs may be locatable on the downstream side of the apparatus. If the apparatus includes the HDA controller, the host interface may be locatable on the upstream side of the HDA controller.

Preferably, the apparatus is combined with a memory storage for storing vendor specific instructions and/or configurations of the one or more non-HDA compatible CODECs. This is advantageously as it makes the architecture very flexible since vendor-specific commands can be supported after the HDA controller and/or emulator logic circuit is fabricated.

Preferably, the vendor specific instructions are selected from the group consisting of: I2C commands, SPI commands and MIDI commands. If the memory storage is also arranged to store configurations of the one or more non-HDA compatible CODECs, the emulated response may thus be based on the stored configurations.

According to a second aspect of the invention there is provided apparatus locatable between a host interface on the upstream side of the apparatus and one or more Coder/Decoders (CODECs) on the downstream side of the apparatus, the apparatus comprising: a High Definition Audio (HDA) controller connectable to the host interface on the upstream side of the apparatus; and a logic circuit on the downstream side of the HDA controller, the logic circuit being connectable to the one or more non-HDA-compatible CODECs on the downstream side of the apparatus and being compatible with the HDA controller on the upstream side of the logic circuit, the logic circuit being arranged to be able to send responses to the HDA controller, during start up and during normal operation, which emulate the responses of HDA-compatible CODECs.

Features described in relation to one aspect of the invention may also be applicable to the other aspect of the invention.

### BRIEF DESCRIPTION

A known arrangement has already been described with reference to FIGS. 1, 2 and 3 of the accompanying drawings, of which:

FIG. 1 shows one conventional HDA architecture;

FIG. 2 is a modified version of FIG. 1 to illustrate the idea of streams and channels in data transmitted over the HDA link; and

FIG. 3 shows the structure of frames transmitted over the HDA link of FIG. 1.

The foregoing aspects and many of the attendant advantages of this invention will become more readily appreciated as the same become better understood by reference to the following detailed description, when taken in conjunction with Figures of the accompanying drawings, of which:

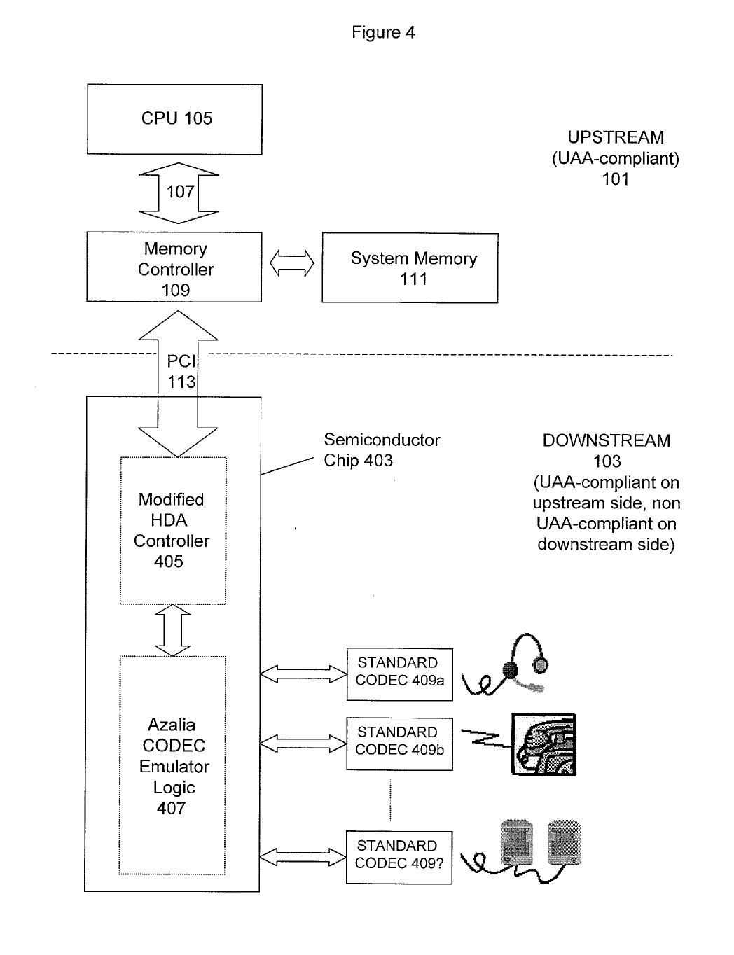

FIG. 4 shows HDA architecture comprising a modified HDA controller and an Emulator Logic according to one embodiment of the invention;

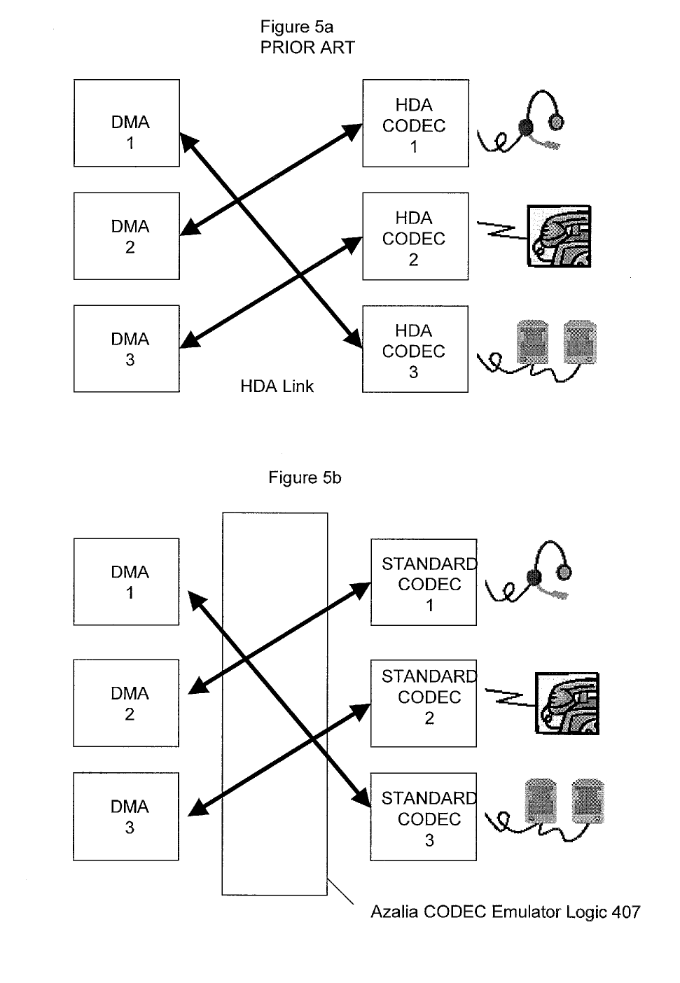

FIG. 5a shows the DMA to CODEC connection in conventional HDA arrangements;

FIG. 5b shows the DMA to CODEC connection in the embodiment of the invention illustrated in FIG. 4;

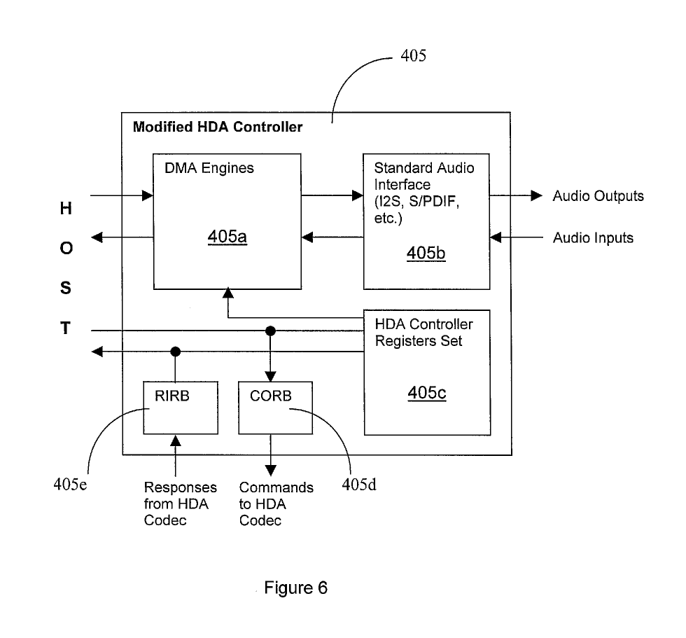

FIG. 6 is a functional block diagram of the modified HDA controller of FIG. 4;

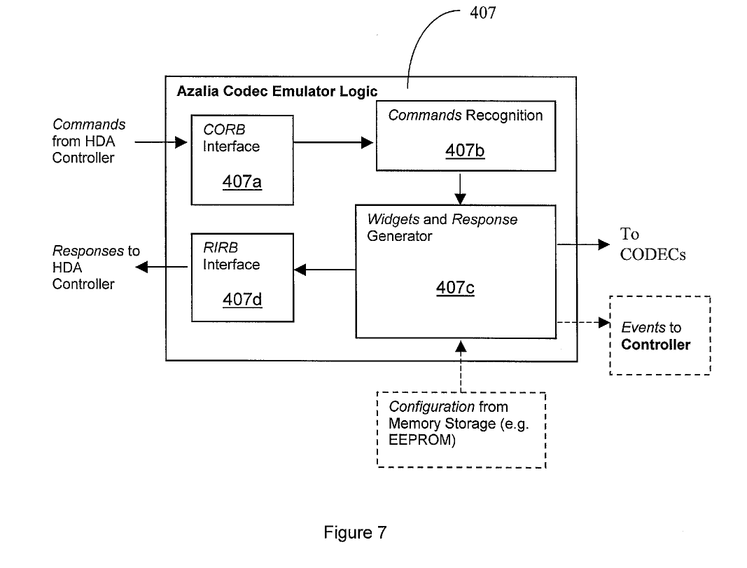

FIG. 7 is a functional block diagram of the emulator logic of FIG. 4; and

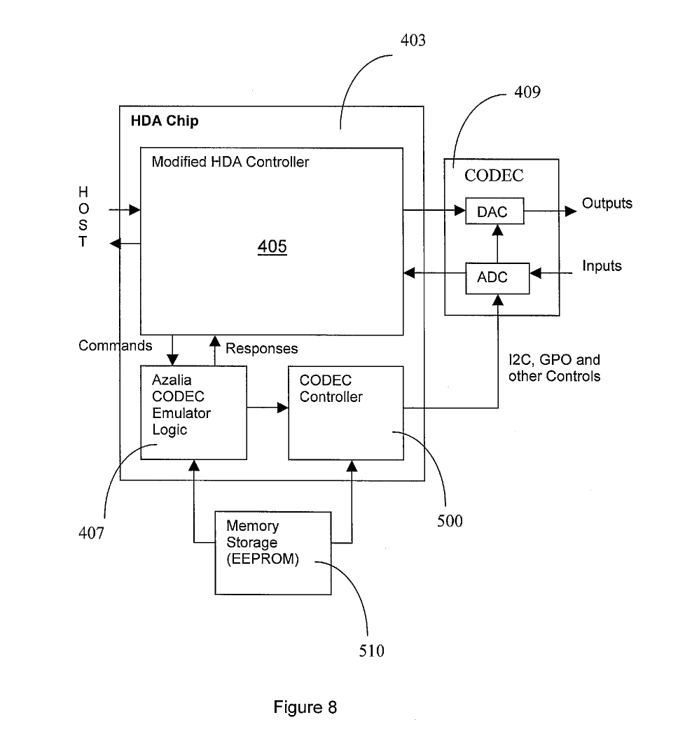

FIG. 8 shows another HDA architecture which forms the second and third embodiment of the invention.

### DETAILED DESCRIPTION OF A PREFERRED EMBODIMENT

As discussed, the concept of the invention is to modify the HDA Controller such that it can be connected downstream to standard CODECs rather than only to UAA-compatible CODECs. This means addressing two problems: firstly the physical problem of connecting an HDA controller with standard (non-HDA compatible) CODECs given that standard CODECs do not have the appropriate HDA-link interface and secondly, the problem of communication between the HDA controller and standard CODECs given that they do not operate with the same protocol.

FIG. 4 shows one embodiment of the invention. In FIG. 4, the upstream side 101 is exactly the same as in the conventional HDA architecture, like that shown in FIG. 1, so the same reference numerals have been used here. In summary, the upstream side includes a CPU 105 connected to a memory controller 109 via a host bus 107. The memory controller has access to system memory 111 and is connected to the downstream side 401 via a PCI 113 (or some other suitable interface).

However, on the downstream side 401, the arrangement is very different. In this embodiment, a single semiconductor chip 403 includes a modified HDA controller 405 together with logic 407 which emulates the performance of the Azalia CODECs. The chip 403 is connected on the downstream side to one or more standard CODECs (e.g. I2S, SPDIF) 409a, 409b . . . .

On the upstream side of the modified HDA Controller 405, the system memory 111 “sees” the same HDA Controller as in conventional systems. Thus, the new architecture does not affect compliance with UAA systems and there need not be any change to the host-HDA interface 113. On the upstream side of the Azalia CODEC logic 407, the modified HDA Controller “sees” the same Azalia CODECs as in conventional systems because the Azalia CODEC emulator logic 407 is designed to appear just like the HDA link and Azalia CODECs of conventional systems. Thus the bus driver can still be loaded correctly. On the downstream side of the Azalia CODEC emulator logic 407, however, the interface is non-UAA compatible and can be connected to one or more standard CODECs 409a, 409b . . . .

FIG. 6 shows a functional block diagram of the HDA Controller 405 which comprises DMA Engines 405a communicating with the memory controller 109, a Standard Audio Interface 405b connected to the DMA Engines 405a, a HDA Controller Registers Set 405c, CORB and RIRB buffers 405d,405e. The functions of each of these components are well-documented in “Intel High Definition Audio Specification Revision 1.0, Apr. 15, 2004” and will not be elaborated here.

In the arrangement of FIG. 4, the HDA link has been completely removed. The Azalia CODEC emulator logic 407 is designed to replace the HDA link and the Azalia CODECs of conventional systems. However, this means that some functions must be moved upstream onto the chip 403 and be performed by the Azalia CODEC emulator logic. FIG. 7 illustrates a functional block diagram of the emulator logic 407. As is apparent from the figure, the emulator logic 407 includes a CORB Interface 407a for receiving commands from the CORB buffer 405d of the HDA Controller 405, a Commands Recognition section 407b, a Widgets and Response Generator 407C and a RIRB Interface 407d.

Commands from the host pass through the HDA controller 405 and is received by the CORB interface 407a. The CORB interface 407a, together with the HDA controller, functions like a DMA engine that access the host memory 111 directly without external software intervention. Once an appropriate address is setup in the HDA controller 405, the CORB interface together with the controller 405 fetch the commands from the host memory 111. Likewise for the RIRB interface 407d, this is also a DMA engine capable of communicating with the host memory 111 directly. Instead of reading commands from the host memory, the RIRB interface forwards and places responses into the host memory 111. Similar to the CORB interface 407a, the RIRB interface 407d does not require any external software intervention to perform the DMA operation except that the host needs to program the required address for the forwarding operation. Typically, for every command received by the CORB interface, a response is expected from the response generator.

The Commands Recognition module 407b performs tasks of understanding the commands from the host (as received by the CORB interface) and translates the commands so that the translated commands are understood by the non-Azalia compliant CODECs. To elaborate using an example of an Azalia command that programs the CODECs 409a, 409b . . . to stream audio at a particular sampling rate, the Commands Recognition module 407b interprets the incoming Azalia command as received from the CORB interface 407a, translates this information into “event” instructions and passes the translated information to the Widgets and Response Generator 407c for programming of the CODECs 409a, 409b . . . and further processing.

The Generator 407c contains registers which represent the HDA compatible CODEC it is emulating and processes the translated “event” instructions to generate the appropriate responses according to the command received from the host. Further, the event instructions are used to generate the I2C/GPO commands for the CODECs 409a, 409b . . . .

The functions of the emulator logic 407 are further described with reference to three particularly important functions:

Function 1: Enumeration

As already mentioned, after power up, the host performs enumeration to establish the number of I/Os i.e. the number of CODECs connected downstream. In prior art arrangements, because the CODECs are HDA-compatible, enumeration is easy via the HDA link. However, in the invention, it is the function of the Azalia CODEC emulator logic 407 to receive commands from the host and send appropriate responses during enumeration. Thus, the emulator logic 407 informs the Operating System (e.g. Windows XP or similar) of the capabilities of the attached audio devices for example how many input/output devices the CODEC can support, how many channels there are per input/output device, the color coding of each channel jack and the sample rate each input/output device supports. In this way, the Azalia logic emulates the HDA-compatible CODECs and deceives the host during enumeration that Azalia CODECs are connected. That is, rather than direct responses from the HDA CODECs to the host's enumeration queries, the Emulator Logic simulates appropriate responses, depending on the number and type of standard CODECs connected, to make it appear to the host that a number of Azalia compatible CODECs are connected instead.

Function 2: Streaming

As shown in FIG. 2, the HDA link provides connections between the DMA engines in the HDA Controller and the Azalia CODECs, for transmission of frames containing streams and channels. For each DMA engine, while some given data is being transmitted, there is a “fixed” connection between the DMA engine and the appropriate CODEC or CODECs. The HDA link operates in a time-multiplexed fashion, which means that, for the portion of the cycle in which the DMA is receiving or transmitting, the DMA engine is in use but, for the remainder of the cycle (when the other DMAs are transmitting), the DMA is not used but is nonetheless out of action for other transmissions because it is reserved for its particular CODEC. In the FIG. 4 arrangement, the Azalia CODEC emulator logic must perform the same streaming function.

FIG. 5a is a schematic drawing of the conventional arrangement of the connection between the DMA engines and the CODECs via the HDA link. FIG. 5a is really just a schematic diagram of the lower portion of FIG. 2. Referring to FIG. 5a, consider the case where data is being received by each CODEC 1, 2, 3. CODEC 3 is required to receive first, so establishes a direct connection with DMA engine 1. For the time taken to receive the CODEC 3 data, the connection between CODEC 3 and DMA engine 1 is fixed. Then, CODEC 1 is required to receive (while CODEC 3 is still operating), so, because DMA engine 1 is already in use, a direct connection between CODEC 1 and DMA engine 2 is set up. For the time taken to receive the CODEC 1 data, the connection between CODEC 1 and DMA engine 2 is fixed. Then, CODEC 2 is required to receive (while CODECs 1 and 3 are still operating) so, because DMA engines 1 and 2 are already in use, a direct connection between CODEC 2 and DMA engine 3 is established. For the time taken to receive the CODEC 2 data, the connection between CODEC 2 and DMA engine 3 is fixed.

In FIG. 5b, however, there is no HDA link and the function of the HDA link is performed by the Azalia CODEC emulator logic 407. The Azalia CODEC emulator logic operates in exactly the same way as the HDA link of the prior art i.e. establishes a fixed connection between a CODEC and a DMA engine whilst data is being transmitted (via the CORB interface 407a, Commands Recognition section 407b and Widgets and Response Generator 407c). Time multiplexing may also be redundant (although still possible to be used) for the DMA engine using the Azalia CODEC emulator logic 407. Without time-multiplexing, data through-put and bandwidth for the BUS may be enhanced.

Function 3: Communication Between the Controller and CODECs, CORB and RIRB

As described above in relation to FIG. 3, in the prior art, the HDA controller converts data into the appropriate frame formation for transmission through the HDA link to the HDA Controllers. Because the HDA CODECs work with the same protocol, they are able to decipher that framed data. In the FIG. 4 arrangement, however, there is no need for the HDA controller to convert the outgoing data into frames (because it is not communicating with HDA CODECs), so the modified HDA controller 405 does not frame the outgoing data. Instead, the Azalia CODEC Emulator Logic 407 converts the data received from the HDA controller and converts it to the appropriate format for the particular standard CODECs that are connected. It is apparent that the conversion is performed by the Generator 407c.

As already mentioned, in the prior art arrangements, outbound commands from the CORB are placed in the control bits at the start of each frame. The control bits are then received by the CODEC and the appropriate action is taken. In the arrangement of FIG. 4, however, because the data is not framed, command data cannot be included at the start of each frame. Instead, the emulator logic handles and interprets the commands and performs the requested functions. Thus, even when the HDA link is absent, the commands can still be dealt with as if the HDA link is present, because the emulator logic can interpret and deal with the commands. This is important so that the driver does not see any difference and can still be loaded correctly. Also, the emulator logic interprets responses from the CODECs and replies with the correct responses.

Thus, the Emulator Logic allows the driver to know what features are supported and informs the Operating System accordingly. Also, during enumeration, the emulator logic sends information to the host to make it appear as if Azalia CODECs are connected. During normal operation, the emulator logic receives and sends commands and responses between the CODECs and the HDA controller.

By combining the HDA Controller and logic emulating the HDA link and Azalia CODECs on a single chip, the user is able to use non-UAA-compatible CODECs on the downstream side. This gives the user a much greater choice and, given that many standard CODECs have a better performance than HDA specific CODECs, the user can thus enjoy better sound quality while still making use of the HDA system. Also, combining the HDA Controller and Azalia CODEC emulator logic onto a single piece of silicon reduces the cost.

An aim of UAA is to provide users with a class driver architecture that provides basic audio functionality in an operating system (OS) and to offer an alternative to third-party drivers for users who experience compatibility problems with audio on their systems or who may not need advance audio features. For example, it is proposed to use a standard Microsoft® audio driver for Windows Vista™ OS so that the audio chip manufacturer need not supply any driver for its audio chip. The advantage of this is that as long as the audio chip is Windows® compliant, then it can be supported by the Microsoft® driver. However, with this initiative, the audio chip manufacturer no longer has control over the driver and thus is unable to control any proprietary function on its audio chips. For example, in audio card products from Creative, digital-to-analog converters (DAC) and analog-to-digital converters (ADC) of a CODEC are controlled via I2C or GPO ports to program the DACs/ADCs into an appropriate state for a particular function. For example, and using I2C as example, when power up, the host sends a stream of I2C commands to the DACs/ADCs to put these into power-on state. Subsequently, when the host starts the audio stream, another set of I2C commands are sent to unmute outputs of the respective audio devices connected to the CODECs. Similarly, when the host initiates sampling rate changes, specific I2C commands are required. These commands are specific to the CODEC chip vendor and the Microsoft® standard driver does not support these vendor specific commands.

A second embodiment of the present invention aims to address the above shortcoming and this is shown in FIG. 8 (see also text in dotted lines of FIG. 7) which is similar to the configuration of FIG. 4, except with additions of a CODEC controller 500 and a memory storage, and in this embodiment, the memory is in the form of an EEPROM 510.

The EEPROM 510 serves as a command storage in which vendor-specific I2C commands for the DAC/ADC are stored. Since the commands and instructions from the emulator logic 407 are passed through the controller 500, the controller 500 is able to monitor “events” or operations that require vendor-specific commands. For example, power-up is such an event and when “power-up” instructions are received from the Emulator Logic 407 (i.e. from Generator 407c), the controller 500 executes the following steps:
a. recognizes the event;
b. fetches a vendor specific I2C command from the EEPROM 510 corresponding to that event; and
c. transmits the I2C command to the intended CODEC to program the DAC/ADC based on the I2C address of the command.

The use of the controller 500 together with a separate (i.e. external to the controller 500) EEPROM 510 to determine when vendor specific I2C commands are required and makes such commands available create a very flexible architecture since it is UAA compliant and still allows vendor-specific commands to be supported. The architecture is also not restricted to certain types/models of CODECs (or DACs/ADCs) since the programming of the EEPROM can be performed during assembly of the sound cards (or motherboard) and thereafter surface mounted, and not during the fabrication of the HDA controller chip. It is apparent that as long as the corresponding vendor specific I2C commands are programmed into the EEPROM, the CODECs (and their respective DAC/ADC) can be configured without the use of a vendor-specific audio driver, which is not catered for in a UAA compliant audio architecture. Of course, a vendor-specific audio driver can be used as long as the driver created is compliant with Microsoft driver guidelines. However, having the architecture as proposed above eliminates the costs associated with developing such a driver. Moreover, the architecture is also adapted to function using a standard Microsoft driver.

It should be apparent that the above architecture could be extended to other interfaces or connections such as General Purpose Output (GPO) interface, Serial Peripheral Interface (SPI) or MIDI.

The use of the EEPROM 510 also extends the functionality of the audio architecture which forms a third embodiment of the present invention. To elaborate, it is common for product developers to provide different audio chips (CODECs) with different functionalities depending on product requirements (for example, varying the number of input/output devices a CODEC can support, changing the number of channels per input/output device, using different colour coding for each channel jack and defining the sample rate). As explained in the first embodiment, it is preferred to have the emulator logic 407 fabricated in the same silicon as the HDA controller 405 and this would mean programming the configurations of the CODEC that the emulator logic 407 is emulating during the fabrication of the modified HDA controller IC. Even if the emulator logic 407 is fabricated as a separate component, this is also a problem since this restricts the functionality of the modified HDA controller/emulator logic only to selected CODECs.

To address this, configurations about the CODEC such as default values of important parameters and “Verbs” are stored in the EEPROM 510. For example, the HDA CODEC architecture uses “Widgets” to define different function groups such as I/O Pin Widget or a DAC Widget etc. If the emulator logic 407 is pre-programmed during fabrication to emulate predetermined Widgets, this would require different emulator logics 407 to support different CODEC configurations. However, it is proposed that the Widget parameters are stored in the EEPROM 510 accessible by the emulator logic 407. At power-on-reset, the configurations stored in the EEPROM are downloaded and stored in the internal memory of the emulator logic 407. When a response is required (for example, a command is received from the host as explained in the passage above describing FIG. 7), the Widgets and Response Generator 407c of the emulator logic 407 responds by obtaining and forwarding a corresponding parameter of the configurations from the internal memory.

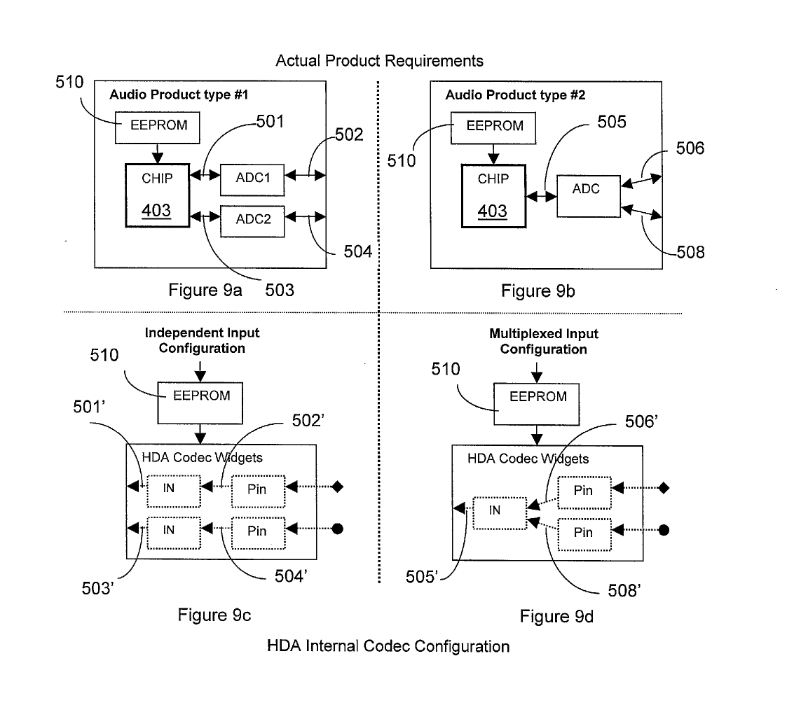

FIG. 9a is a simplified arrangement of an architecture that requires the semiconductor chip 403 to support two independent ADCs, ADC1 and ADC2, each with its own input/output 502,504. FIG. 9b, on the other hand, is a simplified arrangement of another architecture that requires the semiconductor chip 403 to support a single ADC with two inputs/outputs 506,508. Normally, this would require two different semiconductors 403 with respective emulator logics 407 configured to emulate each configuration. However, the third embodiment proposes that the specific configuration of the ADCs by which the semiconductor chip 403 is intended to support be stored in the EEPROM 510 and thus, the semiconductor chip 403 can be fabricated in a generic manner without regard to the CODEC configuration.

Depending on the product architecture, the EEPROM 510 is programmed with the configuration specific to that architecture and the emulator logic 407 can then obtain the configuration as and when required for emulating responses to the HDA Controller 405. FIGS. 9c and 9d, shows how the HDA I/O Pin Widget is being reconfigured in the semiconductor chip 403 based on the configuration obtained from the EEPROM to support the actual ADC configuration. Similar reference numerals are used to represent the emulated pins with the addition of a symbol “prime”.

In this way, the HDA CODEC pin Widget can be reprogrammed to a desired configuration to serve a wide range of product requirements. This also reduces chip development costs as a generic HDA controller 205 and emulator logic 407 can be manufactured and then using the EEPROM 510 to define the product type/configuration.

The described embodiments should not be construed as limitative. For example, it is preferred to fabricate the logic 407 and HDA controller 405 as one integrated circuit (or single semiconductor chip) because this is more cost efficient. However, this is not necessary so, since it is envisaged that the logic 407 can be fabricated as separate integrated circuit which is then connectable to a conventional HDA controller via an AC Link. The CODEC controller 500 for the second embodiment can then be integrated within the same silicon chip as the emulator logic 407 or alternatively as a separate component, although the latter is less preferred.

Of course, it is envisaged that the memory storage 510 can be integrated within the controller 500 but this is not preferred since the vendor I2C commands must already been programmed when fabricating the HDA controller and this limits the flexibility of the architecture.

1. Apparatus arranged to communicate with a host interface and one or more non-High Definition Audio (HDA)-compatible Coder/Decoders (CODECs), the apparatus comprising
a logic circuit connectable to the one or more non-HDA-compatible CODECs and being compatible with a HDA controller, the logic circuit being arranged to send responses to the HDA controller, which emulate responses of HDA-compatible CODECs.

2. The apparatus of claim 1, further comprising a said HDA controller that is compatible with the logic circuit and which is connectable to the host interface.

3. The apparatus of claim 2, wherein the apparatus is in the form of an integrated circuit.

4. The apparatus of claim 2, wherein the host interface is a Peripheral Component Interface (PCI).

5. The apparatus of claim 2, wherein at least one of the one or more CODECs is a CODEC of a type selected from the group consisting of:
Sony/Phillips Digital Interface (S/PDIF) and Inter-IC-Sound (I2S).

6. The apparatus of claim 1, wherein the logic circuit communicates with the one or more non-HDA-compatible CODECs using data selected from the group consisting of: multiplexed and un-multiplexed data.

7. The apparatus of claim 1, wherein the host interface is locatable on the upstream side of the apparatus, and the one or more non-HDA-compatible CODECs is locatable on the downstream side of the apparatus.

8. The apparatus of claim 2, wherein the host interface is locatable on the upstream side of the HDA controller.

9. In combination, the apparatus of claim 1 and a memory storage for storing vendor specific instructions of the one or more non-HDA compatible CODECs.

10. The combination of claim 9, wherein the vendor specific instructions are selected from the group consisting of: I2C commands, SPI commands and MIDI commands.

11. The combination of claim 9, wherein the memory storage is also arranged to store configurations of the one or more non-HDA compatible CODECs.

12. The combination of claim 11, wherein the emulated responses are based on the stored configurations.

13. In combination, the apparatus of claim 1 and a memory storage for storing configurations of the one or more non-HDA compatible CODECs.

14. Apparatus locatable between a host interface on the upstream side of the apparatus and one or more non-High Definition Audio (HDA)-compatible Coder/Decoders (CODECs) on the downstream side of the apparatus, the apparatus comprising:
a High Definition Audio (HDA) controller connectable to the host interface on the upstream side of the apparatus; and
a logic circuit on the downstream side of the HDA controller, the logic circuit being connectable to the one or more non-HDA-compatible CODECs on the downstream side of the apparatus and being compatible with the HDA controller on the upstream side of the logic circuit, the logic circuit being arranged to be able to send responses to the HDA controller, during start up and during normal operation, which emulate the responses of HDA-compatible CODECs.
